(19) United States
(12) Patent Application Publication
(10) Pub. No.: US 2003/0114187 A1
(43) Pub. Date: Jun. 19, 2003

(54) Mobile communication server

(75) Inventor: David E. Jackson, Atkins, IA (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/313,858

(22) Filed: Dec. 6, 2002

Related U.S. Application Data
(60) Provisional application No. 60/341,535, filed on Dec. 17, 2001.

(51) Int. Cl. H04Q 7/20; H04M 1/00; H04B 1/38

(52) U.S. Cl. 455/552; 455/426

(57) ABSTRACT

A control is provided for evaluating a particular message to be sent from a mobile vehicle to a base station, or received by the vehicle from the base station. The control evaluates the particular message and the available communication systems to transmit the message. Weighting factors, and preferably a table, are included into the control which evaluates the particular message, and the current bandwidth for an optimum one of the communication systems. If the message can be sent on the optimum communication system, given the present usage, then that optimum system is utilized. If not, then the weighting factors/table looks at the second selected optimum system to determine whether the message would be best sent on that system. This process can continue through three or even more options. The operator of the mobile communication system is able to insert weighting factors that would control how and when the decision to move from the most optimum to the second most optimum is made.

### BACKGROUND OF THE INVENTION

This application claims priority to U.S. Provisional Patent Application No. 60/341,535 filed Dec. 17, 2002.

The application relates to improvements in two-way communication between mobile vehicles and a home base.

A home base, such as a police station, typically must be in two-way communication with each of several vehicles on the road. Thus, police cars typically have any one of several types of radios which are in two-way communication with the base.

Over the past several years, more and more wireless communication between the vehicles and the base has been occurring. As an example, most police vehicles today have a laptop computer for receiving and processing information, and for sending information to the base. The vehicles are also provided with information such as AVL (automatic vehicle location) information which is sent to the base. Police officers will often enter their reports into their laptop computer and transmit it to the base, rather than waiting until the end of a shift. At a traffic stop, the police officer may query the base with regard to the license plate, the identity of an individual who is stopped, fingerprints could be scanned and sent, etc. The base will often send dispatch instructions to the vehicle over these same wireless connections.

In the past, while a police vehicle may be provided with more than one way of communicating, no analysis of the available means of communication has been made.

Vehicle location information has typically been sent over a two-way radio link.

However, in the event the vehicle is outside of the radio range, then some other means may be utilized.

As the number of types of communication devices available on a police car increase, and as the types of data and the size of data which is to be transmitted to and from the base from the vehicles increases, it would be desirable to have a controlled program for evaluating available communication options and selecting the best.

Each type of two-way radio has an optimum message size. As an example, three known two-way radio systems, RD-LAP, Open Sky, EDACS are optimum for message sizes of 100-1000 bytes. A TDMA network, on the other hand, is optimum for smaller messages of 20-100 bytes. Some available communication systems have a monetary cost that is higher than others. Further, some of the systems may be desirably dedicated for receiving and processing a particular type of message. Thus, an optimum controller might wish to maintain the band width on this type of communication system for one particular type of message.

No known control has been provided which would evaluate a particular message and determine which means of communication would be best for communication of that particular message.

### SUMMARY OF THE INVENTION

In a disclosed embodiment of this invention, a controller based upon a mobile vehicle, such as a police vehicle, is able to evaluate a particular type of message to be sent, and select the optimum means for transmitting that message. The operator of the communication system is able to program a table which evaluates the priority of a particular message, and the available options for transmitting that message. The table will allow the control to select the best communication method given the present usage at the time of the several types of communications available, the monetary cost, the available band width, and the effect on the available band width by the transmission of the particular message. Of course, the operator may utilize any other weighting factors while programming the table.

In disclosed embodiments, the controller on the police vehicle receives a particular message to be sent from the vehicle. That message is processed through a control algorithm that includes evaluating the priority, and a series of “desired” communication methods for the particular type of message. The instantaneous use of the bandwidth on the most desired means of communication is evaluated. If the particular message could be sent over the most desired, then the most desired is utilized. If not, then the control proceeds to evaluating whether the second most desired use would be available.

These and other features of the present invention can be best understood from the following specification and drawings, the following of which is a brief description.

### BRIEF DESCRIPTION OF THE DRAWINGS

FIG. 1 is a schematic view of a base/mobile communication network.

FIG. 2 shows a control table.

FIG. 3 is a flowchart of the algorithm.

### DETAILED DESCRIPTION OF THE PREFERRED EMBODIMENT

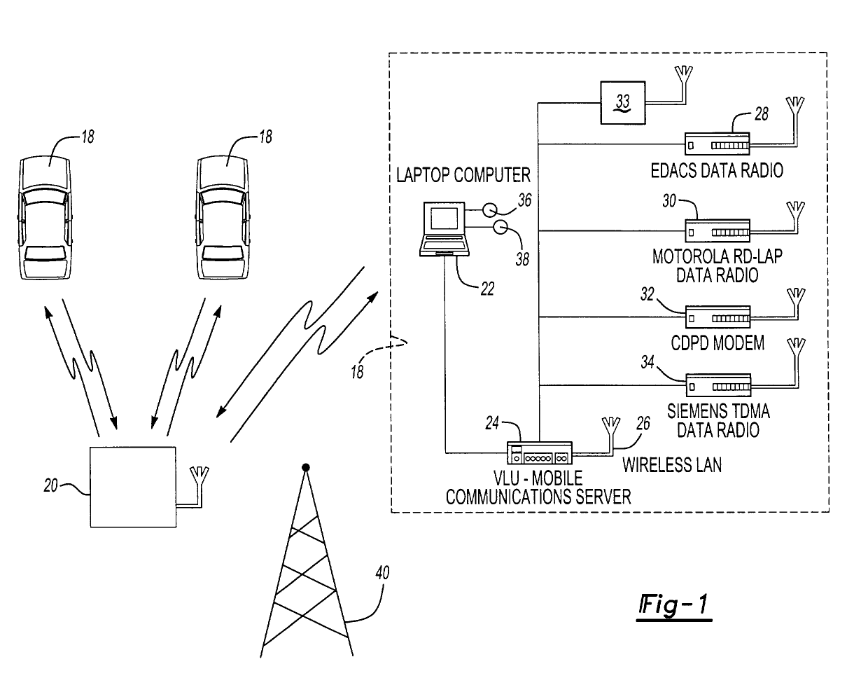

A mobile communication system is illustrated in FIG. 1 schematically. As shown, a number of vehicles 18 may represent vehicles, which need to be in two-way communication with a base 20, such as police vehicles. The vehicles 18 can communicate through various types of commercially available two-way radio, CDPD (cellular digital packet data) systems, or wireless LAN networks.

Each of the vehicles typically is provided, as an example, with a laptop computer 22 to enter, process, receive and evaluate information sent to and from and received from base 20. Laptop 22 communicates with a mobile communication server 24. Mobile communication server 24 has a transmitter/receiver 26 for communicating with a wireless LAN network. As is known, the wireless LAN network is optimum for sending large amounts of data, such as field reports. However, the vehicle 18 needs to be in proximity to a local area network receiver such as shown schematically at 40.

The vehicle 18 is shown provided with four other ways of two-way communication with the base 20. It should be understood that this invention would typically relate to any communication system which has at least two types of two-way communication, although several more are illustrated in this figure to show the extreme power of the present invention. Communication system 28 may be an EDACS data radio. Communication system 30 may be an RD-LAP data radio such as is available from Motorola. Communication system 32 may be a CDPD modem. Communication system 34 may be a TDMA data radio such as is available from Siemens VDO Automotive. Communications system 33 may be a proprietary modem from any new source.

As is known, the laptop 22 can receive information to be transmitted to the base such as shown schematically by various input nodes 36. The police officer, or other operator of the vehicle 18, is able to input information such as license plates, scanned fingerprints, etc., for transmission to the base such that the base can report back after an evaluation of the transmitted information. Further, vehicle location information is input such as shown schematically at 38, either into the laptop 22 or directly into the server 24 for transmission to the base. All of this inputting of information is as known.

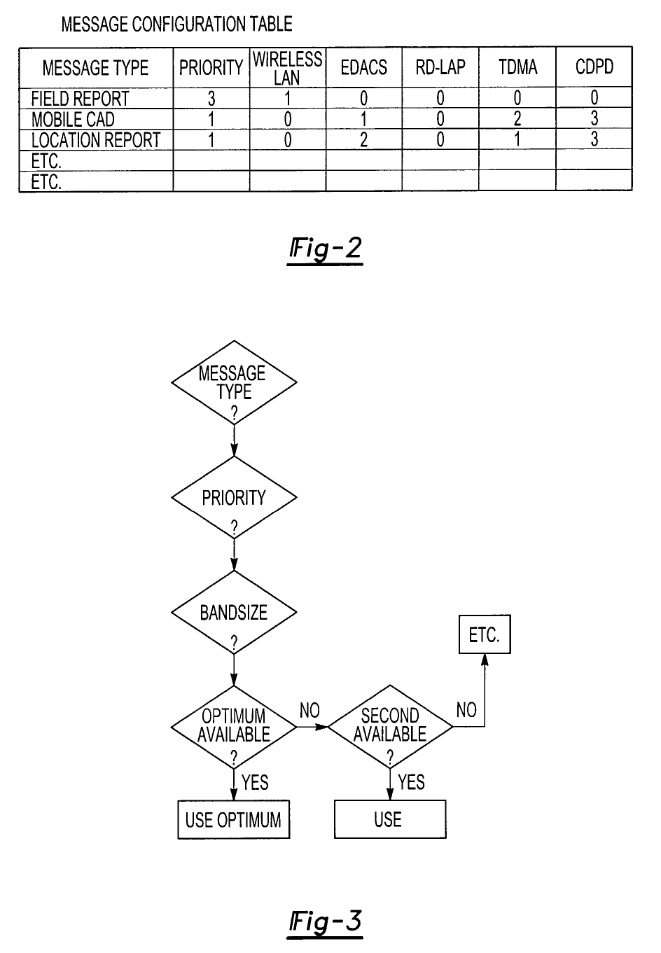

The present invention provides a way of having the server 24, or some other control, evaluate the best communication system to be utilized for a particular type of message. Thus, an operator of the communication system illustrated schematically in FIG. 1 is able to program a table such as shown in FIG. 2. A number of types of messages are entered into the table and a priority is assigned to each of the messages. As an example, a police officer will periodically make a field report, and will enter it into the computer. However, this would be a relatively routine type of data to send to the base 30. Thus, it is shown with a lower priority. Mobile computer-aided dispatch (CAD) has a higher priority. This would be instructions from the base to the vehicle to proceed to a particular location. Similarly, a location report from the vehicle to the base occurs periodically and has a somewhat high priority. Other types of information such as stopped vehicle information would have an even higher priority. Different types of information could be sent on a stopped vehicle, and some would have longer message sizes and other smaller. As an example, a police officer could request information about a license plate which would be a relatively small message packet. On the other hand, mobile fingerprinting and digitizing technology is becoming more available which will allow a police officer to transmit a fingerprint digitally. Transmitting such a message would require large data size, and may have a different return path that is more optimal.

As shown in the sample table, the mobile field report may only have one available type of transmission mode. The field report would wait until the vehicle 18 came within range of the wireless LAN receiver 40. At that time, the field report would be transmitted. However, none of the other communication systems 28, 30, 32 or 34 would be utilized or tied up with transmission of the field report, if that is the programming that the operator desires.

The mobile CAD would be sent from the base 20 with a high priority. Thus, the wireless LAN would not be a good option for receiving or transmitting this information. On the other hand, the EDACS system which is optimum for message sizes of 100-1000 bytes, would be given the top priority for this type of message. The TDMA type data radio is also optimum for smaller message sizes than one might expect for a mobile CAD communication. Thus, it is listed as the second option for sending and receiving the mobile CAD report. If the EDACS was otherwise not the best choice based upon any number of criteria that could be built into the table, then the TDMA would be utilized. Examples of criteria which could be utilized might be that the priority for the mobile CAD message is high and yet the EDACS would not be available based upon other communication already taking up its bandwidth for some period of time. As an example, if the EDACS was otherwise taken up with transmission of a message and a mobile CAD report came up for transmission, the controller might decide that the priority of the mobile CAD would justify the use of the TDMA communication system. If the control also determines that the TDMA is not immediately available, then CDPD, which might have a higher monetary cost, would be selected. Also, each of the two-way radio types potentially move out of range, and at such time, the CDPD may be the only available option.

Similarly, a location report has a high priority, but would have the reverse flow path of first choice and second choice from the mobile CAD.

The control thus includes a “cost” algorithm, takes into account the monetary cost, the present bandwidth utilization, and the impact of transmitting the particular message on the remaining available bandwidth. As an example of this criteria, if a mobile CAD report was for example relatively large, and the EDACS was not available. The control might determine that the bandwidth which would be taken up by transmission of this message over TDMA would be undesirable, and would then move to the “third” choice CDPD. The operator of the communication system would have to weigh the monetary cost of the CDPD over how the control weights and prioritizes the material to make this choice.

FIG. 3 shows a flowchart of the algorithm. A message type comes in for transmission either from the base to the vehicle, or from the vehicle to the base. The priority is determined and the band size of the message is determined. The algorithm then picks the optimum communication system of the several available. The transmission then occurs.

The particular types of communication systems mentioned above are exemplary only. The present invention is directed to a system which evaluates available communication systems on the particular network and selects an appropriate system based upon an operator selected weighting or algorithm.

One particular value of this system is it accommodates new types of communication technology easily. The users of these types of communication systems are often not highly skilled at communication technology or interface. Thus, upgrading to add additional communication technologies has often resulted in complete system replacement. With the above system, all that needs to be done to change a system to allow the use of an additional communication technology is to replace/rewrite the control program.

The base also has a computer 42 which would utilize a similar weighting table to determine which type of communication system to use to send information to the vehicle, somewhat as described above with regard to the mobile CAD information.

1. A control system for a mobile communication system including:
a control operable to receive messages for transmission through any one of several types of communication systems, said control being provided with weighting factors to evaluate the particular message and particular available communication systems, and select an optimum communication system based upon several weighting factors.

2. A control as set forth in claim 1, wherein among said weighting factors are the size of the message to be sent.

3. A control system as set forth in claim 1, wherein among the weighting factors is the priority to be assigned to the message.

4. A control system as set forth in claim 1, wherein said control is to be mounted on a mobile vehicle, and to receive information from a computer on the mobile vehicle.

5. A mobile communication system as set forth in claim 1, wherein a control as set forth above is provided both upon a stationary base station and said mobile vehicle.

6. A method of transmitting information to and from a mobile vehicle comprising the steps of:
(1) providing a plurality of two-way communication systems for communicating from a mobile vehicle to a base;
(2) providing a control for receiving messages to be transmitted, and for selecting an optimum one of said plurality of available communication systems based upon weighting factors, said control receiving a particular type of message, evaluating said particular message, and determining an optimum of said plurality of available communication systems based upon said weighting factors.

7. A method as set forth in claim 6, wherein said weighting factors are built into a table selected by an operator for the mobile communication system.

8. A method as set forth in claim 6, wherein said control is mounted on a mobile vehicle.

9. A method as set forth in claim 7, wherein said table includes priority information, and a hierarchy of optimum available communication systems for the particular type, including priority and size of message.

10. A method as set forth in claim 9, wherein said mobile vehicles are police cars.

11. A two-way communication system comprising:
a plurality of mobile vehicles in two-way communication with a base, each of said mobile vehicles being provided with a computer, said computer communicating with a communications server, said communications server being operable to receive and send information to said base over a plurality of distinct communication system types, and said control including weighting factors for determining an optimum one of said communications systems based upon operator selected criteria.

12. A two-way communication system as set forth in claim 11, wherein said base also includes a control having the ability to receive and transmit over a plurality of communications systems, and said control being provided with weighting factors for selecting a particular one of said communications systems as being optimal for transmission of a particular message.
